(19) United States
(12) Patent Application Publication
(10) Pub. No.: US 2010/0207712 A1
(43) Pub. Date: Aug. 19, 2010

(54) CONTROL OF THE DISPLAY BACKGROUND ILLUMINATION IN A POWER SWITCH

(76) Inventors: Jörg Braune, Berlin (DE); Thomas Driehorn, Berlin (DE); Ilka Jakubowski, Falkensee (DE); Edeltraud Musiol, Berlin (DE); Andreas Pancke, Berlin (DE); Manfred Schiller, Berlin (DE)

Correspondence Address: HARNESS, DICKEY & PIERCE, P.L.C., P.O.BOX 8910, RESTON, VA, 20195, US

(21) Appl. No.: 12/679,863

(22) PCT Filed: Sep. 24, 2008
(86) PCT No.: PCT/EP2008/062736

§ 371 Date: Mar. 24, 2010

(30) Foreign Application Priority Data
Sep. 26, 2007 (DE) 10 2007 047 166.3

(51) Int. Cl. H01H 73/12; H05B 37/02

(52) U.S. Cl. 335/17; 315/362

(57) ABSTRACT

A power switch includes an electronic overcurrent protection trigger, which receives the power supply thereof from the power supply network monitored by the power switch. In at least one embodiment, the display device of the power switch acquires the power supply thereof from the power supply network monitored by the power switch, and an electronic device powered with voltage from the power supply network monitored by the power switch controls the turning on and off of the background illumination of the electronic display device, which obtains the voltage supply thereof from the power supply network monitored by the power switch, with the aid of an electronically controllable switch as a function of the measured values detected in a measuring device of the electronic device. A method for controlling the turning on and off of the background illumination of a display device of a power switch is also disclosed.

### PRIORITY STATEMENT

This application is the national phase under 35 U.S.C. §371 of PCT International Application No. PCT/EP2008/062736 which has an International filing date of Sep. 24, 2008, which designates the United States of America, and which claims priority on German patent application number DE 10 2007 047 166.3 filed Sep. 26, 2007, the entire contents of each of which are hereby incorporated herein by reference.

### FIELD

At least one embodiment of the invention generally relates to an electromechanical circuit breaker having an overcurrent release, in particular to a low-voltage circuit breaker, which is equipped with a display for displaying the operating parameters, the characteristic figures and fault messages.

### BACKGROUND

Electrical power supply systems comprise high-voltage systems and low voltage systems which are tapped off from them and which extend up to a voltage level of about 1000 V for alternating current, and up to 1500 V for direct current. Low-voltage circuit breakers having electronic overcurrent protection releases are known which are described using the abbreviation ACB (air circuit breakers). Another analog is a closed circuit breaker or a compact switch, which is known by the abbreviation MCCB (molded case circuit breaker). Low-voltage circuit breakers carry out both a switching function and a protection function in low-voltage switchgear assemblies. The current flowing through the circuit breaker is measured and assessed with the aid of an electronic circuit. The electrical power supply systems for loads can be protected against short circuits and overloads on the basis of these values. By way of example, the circuit breaker is tripped by an electromagnetic or thermal release, which operates a number of current-carrying switch contacts.

The low-voltage circuit breakers contain a disconnection unit, operating an electromagnetic release which disconnects the current-carrying power contacts of the circuit breaker in the event of a defined disturbance. The disconnection behavior of the circuit breaker, for example, is set by a variable resistance in this disconnection unit (or electronic trip unit (ETU)), and, in particular, a disturbance is identified on the basis of measured current and voltage parameters, for example their magnitude, or else in some applications by the phase angle between them, and the operation of the circuit breaker is initiated in order to disconnect its current-carrying power contacts.

The electrical parameter values, which are detected in a wide range of ways, are frequently displayed on a screen, for example an LCD monitor, in order to monitor the operation of a circuit breaker. In this case, it is important that the operation of the overcurrent switch in a circuit breaker is not corrupted by any disturbing factors, particularly when a critical supply situation occurs when the operating current that is flowing is two low, that is to say for example the power supply for any additional electronic appliances such as an LCD display must not draw power from the signal to be measured. When a high short-circuit current occurs suddenly and the operating current is relatively low, the disconnection unit in the circuit breaker identifies this and initiates a disconnection process which must be carried out immediately using the energy available in the energy storage capacitor, even before the high short-circuit current can charge the energy storage capacitor to a higher energy level, which would take too long if one were to wait for this. For this reason, conventional solutions offer a voltage supply for an LCD display together with its associated electronic circuit for signal preprocessing only by means of an external auxiliary voltage source. However, this results in additional complexity in providing a suitable, independent voltage source at the point where a circuit breaker is accommodated, incurring additional costs for investment and maintenance, and resulting in additional technical failure sources. Batteries or generators, additional electronic circuits, signal interfaces, etc. must be provided for this purpose.

### SUMMARY

At least one embodiment of the present invention makes it possible to supply a voltage supply for a screen display for an overcurrent protection release of a circuit breaker from the power supply system to be monitored without this influencing the operation of the circuit breaker, that is to say its overcurrent protection release and in particular the disconnection unit, in critical, low-energy situations.

In one example embodiment of the present invention, a circuit breaker comprises an electronic overcurrent protection release, which draws its power supply from the power supply system monitored by the circuit breaker, having a current sensor, a rectifier, an energy storage capacitor and a short-circuiting switch, a disconnection unit, a measurement apparatus for measuring the operating parameters of the power supply system to be monitored, an electronic circuit which processes the detected measured values, at least one electromagnetic release, which is controlled by the disconnection unit, for tripping the current-carrying power contacts of the circuit breaker, and an electronic display apparatus for displaying the detected and/or processed measured values, developed such that the display apparatus of the circuit breaker draws its power supply from the power supply system monitored by the circuit breaker and an electronic apparatus, which is supplied with voltage from the power supply system monitored by the circuit breaker, controls the switching on and off of the background lighting of the electronic display apparatus, which draws its voltage supply from the power supply system monitored by the circuit breaker, with the aid of a switch which can be operated electronically, as a function of the measured values detected in a measurement apparatus of the electronic apparatus. The disconnection of just the background lighting for the display apparatus disconnects the largest energy consumer in this additional display apparatus before a critical situation occurs, but the display apparatus itself nevertheless remains in operation and can in some circumstances still indicate the important detected parameter values although without background lighting, for example because an LCD display can allow an at least monochromatic display solely by virtue of the ambient light.

In a further refinement of at least one embodiment of the present invention, the circuit breaker according to at least one embodiment of the invention is developed such that the voltage level across the energy storage capacitor is detected in the measurement apparatus of the circuit breaker, this at least one detected measured value is compared with at least one predetermined threshold value and processed in an electronic circuit in the measurement apparatus, and a control signal for the switch which can be operated electronically is generated in order to switch the switch on and off. The voltage level of the energy storage capacitor is directly proportional to the energy store supply state of the energy storage capacitor in the circuit breaker and can therefore be used directly as a comparison value for comparison with a predetermined threshold value. A voltage level such as this to be detected can be evaluated both directly in analog form in a comparison circuit and can be digitized in advance by a D/A converter.

In a further, alternative refinement of at least one embodiment of the present invention, the circuit breaker according to at least one embodiment of the invention is furthermore designed such that at least one of the two parameters, the switching frequency and/or the switching duration, of the short-circuiting switch is detected in the measurement apparatus of the circuit breaker, the detected measured values are compared with at least one predetermined threshold value and processed in an electronic circuit in the measurement apparatus, and a control signal for the switch which can be operated electronically is generated in order to switch the switch on and off. The switching behavior of the short-circuiting transistor likewise reflects the energy store supply state of the circuit breaker and can therefore alternatively also be used as a comparison value for comparison with a predetermined threshold value, although a more intelligent electronic evaluation is required for this purpose. The more frequently and/or the longer the short-circuiting switch is switched to a short circuit, the higher is the current to be monitored and the energy storage capacitor therefore becomes more completely charged. If the short-circuiting switch remains open for a relatively long period or continuously, this means that the current to be monitored in the current-carrying power supply system has decreased and, accordingly, the state of charge of the energy storage capacitor is at a lower level. It is therefore possible to calculate the point at which the energy storage capacitor reaches the critical energy store state.

In yet another refinement of at least one embodiment of the present invention, the circuit breaker according to the invention is developed such that the level of the predetermined threshold value for controlling the switching on and off of the background lighting of the display apparatus corresponds to a minimum but still adequate energy store supply from the energy storage capacitor in the circuit breaker through the power supply system to be monitored by the circuit breaker. By presetting this level value, when there is an energy shortage, an energy store is protected against consumption by the display lighting, exclusively for the demand when a disturbance occurs.

In yet another refinement of at least one embodiment of the present invention, the circuit breaker according to the invention is developed such that the electronic apparatus uses the switch which can be operated electronically to control the switching on and off of the entire display apparatus, including its image signal processing electronics, as a function of the detected measured values. In some applications, it is advantageous not only to disconnect the background lighting of the display apparatus as before, but also to disconnect the associated image processing electronic circuit as an energy consumer, in order to exploit even greater reserves of the circuit breaker when the energy supply values in the energy storage capacitor are low. This disconnection could also be carried out as an additional disconnection process, to be carried out in a second stage.

In a further refinement of at least one embodiment of the present invention, the circuit breaker according to at least one embodiment of the invention is developed such that the switch which can be operated electronically is in the form of an electronic switching element, based on semiconductor technology. The embodiment of this switch as a semiconductor element makes it possible to operate the switch easily and directly in an electronic circuit environment, while avoiding the need for mechanical parts which are subject to wear.

In yet another refinement of at least one embodiment of the present invention, the circuit breaker according to at least one embodiment of the invention is developed such that the circuit breaker is a low-voltage circuit breaker. The features of the invention are, of course, also applicable in voltage ranges other than the low-voltage range, although specific accompanying technical circumstances dictate that the advantages of the invention are particularly appropriate in particular for use in the low-voltage range.

In a further refinement of at least one embodiment of the present invention, the circuit breaker according to at least one embodiment of the invention is developed such that the display apparatus is an LCD screen. The use of a liquid crystal screen results in the major advantage that the display can also still be read with the background lighting disconnected, provided that there is sufficient ambient light, that is to say for example that even lighting by means of a flashlight is sufficient to allow the display to be read when it is dark.

In yet another further refinement of at least one embodiment of the present invention, the circuit break according to at least one embodiment of the invention is developed such that the display apparatus is any type of electronic screen. This is particularly advantageous when, as stated above, in one refinement of the invention, the image-processing electronic circuit is in any case switched off as well, in addition to the background lighting of the screen.

In yet another refinement of at least one embodiment of the present invention, the circuit breaker according to at least one embodiment of the invention is developed such that in addition to the background lighting, which can be switched off by means of the switch, for a display apparatus, further additional electrical loads are connected such that they can be switched off. At least one embodiment of the invention makes it possible to connect further electrical loads to a circuit breaker and to supply them with power from the power supply system to be monitored without endangering the operation of the circuit breaker in a low-energy operating state, since these are switched off in good time together with the background lighting for the circuit breaker.

The abovementioned features according to at least one embodiment of the invention are based on a method according to at least one embodiment of the invention for controlling the switching on and off of the background lighting for a display apparatus for a circuit breaker according to one of the above example embodiments, such that at least one parameter characteristic value, which is associated with the power supply drawn from the power supply system to be monitored, is detected in an electronic apparatus, is processed compared with at least one predetermined threshold value and an output signal is generated by means of which a switch which can be operated electronically is switched on and off as a function of the detected measured values and, by it, the background lighting, which is connected in series with it, for the display apparatus, such that when an excessively low energy storage supply from the energy storage capacitor in the circuit breaker is found as a comparison result, the background lighting of the display apparatus is switched off, and, when, in contrast, an adequate energy supply in the circuit breaker is found as the comparison result, the background lighting for the display apparatus is switched on. In one preferred development of the method, the step of detection of the at least one parameter value in the electronic apparatus is detection of the voltage level of the energy storage capacitor. In yet another preferred development of the method, the step of detection of the at least one parameter value in the electronic apparatus is detection of at least one of two parameters, the switching frequency and/or the switching duration of the short-circuiting switch.

The implemented features of at least one embodiment of the present invention make it possible to produce a low-voltage circuit breaker which requires no external auxiliary voltage supply in order to supply power to a display apparatus connected to its power supply, without a disconnection process in the event of a disturbance being endangered in situations in which the energy store supply is low by energy being drawn for subordinate appliances. This improves the reliability and the economy of low-voltage circuit breakers that are used.

### BRIEF DESCRIPTION OF THE DRAWINGS

The present invention will be described in more detail in the following text using two example embodiments and with reference to the attached drawings, in which:

FIG. 1 shows a schematic illustration of a low-voltage circuit breaker having a display apparatus according to the prior art;

FIG. 2 shows a schematic illustration of a low-voltage circuit breaker according to an embodiment of the invention with the voltage level of the energy storage capacitor being detected, and

FIG. 3 shows a schematic illustration of a low-voltage circuit breaker according to an embodiment of the invention with the switching state of the short-circuiting transistor being detected.

### DETAILED DESCRIPTION OF THE EXAMPLE EMBODIMENTS

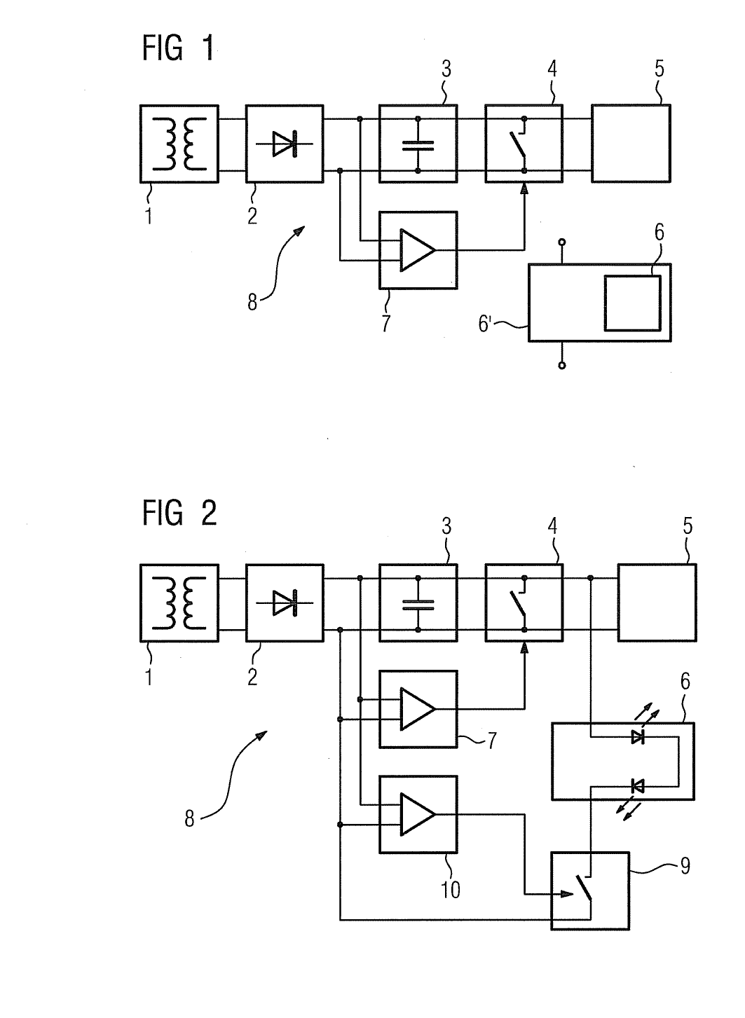

FIG. 1 shows a schematic illustration of a conventional low-voltage circuit breaker 8 having a display apparatus 6, 6′ according to the prior art.

The primary winding of a current transformer 1, which is used as a current sensor, is connected, for example, to the power supply system to be monitored (not illustrated) and, as a result of the electromagnetic coupling preferably provided by an iron core, produces a current at a decreased current level in its secondary winding, with this current being directly proportional to the primary power supply system current. The decreased-magnitude secondary current is then converted in a rectifier unit 2 to a proportional, rectified direct current, and is made available in this form to the further circuit parts of the circuit breaker 8 as their power supply and as a measurement signal, at the same time. An energy storage capacitor 3 which is connected absorbs charge which is proportional to its capacitance and to the applied voltage, and stores this charge as an energy store. Since the current in the electrical power supply system to be monitored is subject to very major fluctuations, the rectified secondary current and, with it, the voltage applied to the loads on the circuit breaker would also be subject to proportionally large fluctuations which would, however, adversely affect the operation of the electronic components.

For this reason, the present embodiment of the circuit breaker has regulating elements which carry out the role of a power supply unit and limit the direct current that is flowing. This is achieved by an electronic circuit 7 which has a measurement apparatus for measuring the operating parameters of the power supply system to be monitored. For example, the measurement apparatus 7 detects the voltage across the energy storage capacitor 3, compares this with an internally predetermined threshold value and short circuits a switch 4 for a time period calculated in proportion to the signal, when the threshold value is exceeded, via which switch 4 a leaking overcurrent can then flow away. The greater the amount of energy in the form of flowing direct current that arrives at the energy storage capacitor 3 via the current transformer 1 from the electrical power supply system to be monitored, the more often, and for longer switching times, the electronic circuit 7 short-circuits the short-circuiting switch 4, thus regulating the voltage level of the energy storage capacitor at a (fluctuating) maximum level. The short-circuiting switch 4 in preferred embodiments is in the form of a switching transistor or else referred to as a short-circuiting transistor, and the excess energy carried away via it is, for example, converted to heat and carried away via a resistor which is not illustrated.

An electronic disconnection circuit 5 is connected to the energy source 3 which is in this way regulated in a fluctuating manner, but limited to a maximum value, and the incoming signal is evaluated with greater or lesser complexity in this electronic disconnection circuit 5, depending on the embodiment of the circuit breaker. For example, rising flanks of the voltage and the phase angle between the current and voltage can be measured and can be used to deduce whether there is a disturbance caused by a short circuit in the electrical power supply system to be monitored. If a disturbance is found, then the disconnection circuit 5 initiates an immediate switching-off process of the circuit breaker. At this instant, the energy store is called from the energy storage capacitor 3 and is supplied to an electromagnetic release (not illustrated) in the circuit breaker, which has to carry out a relatively large amount of mechanical work in order to move its current-carrying power contacts (not illustrated) apart from one another very quickly. The identification of the disturbance by the disconnection circuit 5 is so effective that the result occurs before energy resulting from the large short-circuit current flowing in the event of a disturbance could charge the energy storage capacitor 3 if it were not previously fully charged. For this reason, the energy stored in the energy storage capacitor is very valuable, particularly when a relatively low operating current is flowing and a disturbance suddenly occurs.

When the operating current is low, the energy storage capacitor 3 is charged to a lower voltage level, despite a short-circuiting switch 4 being open all the time, and therefore contains less stored energy. This reduced amount of stored energy must, however, be adequate in the event of a disturbance to supply the disconnection circuit 5 and to allow sufficient energy to be supplied to the electromagnetic release in the circuit breaker over an adequate time period in order to allow this release to reliably carry out its important protection function, quickly and completely interrupting the electrical power supply system to be monitored, by opening its power contacts.

Conventionally, for this reason and for a type of disturbance such as this, all the additional appliances such as a display apparatus 6, 6′ which is connected for monitoring purposes are operated only by an independent additional energy source such as a battery, a generator (not illustrated) and so on. For this reason, the display apparatus with a screen 6 and an image processing electronic circuit 6′ is not connected to the voltage supply for the circuit breaker. In addition, this means that the signal transmission between the disconnection circuit 5 and the image processing electronic circuit 6′ for the display apparatus must also be an interface which electrically decouples the two circuits. Overall, this results in the disadvantages of high costs and the maintenance effort for the additional independent power supply for the display apparatus 6, 6′.

FIG. 2 shows a schematic illustration of one example embodiment of a low-voltage circuit breaker according to an embodiment of the invention which has components largely of the same type as the conventional embodiment of the circuit breaker described with reference to FIG. 1, for which reason the operation of these components of the same type will not be described again, with emphasis being placed on the features according to an embodiment of the invention.

According to an embodiment of the invention, the display apparatus 6, 6′ is connected in parallel with the other electrical loads on the circuit breaker to the energy source for the circuit breaker 8, that is to say to the energy storage capacitor 3, although FIG. 2 does not show the image processing electronic circuit 6′, which should be understood as being connected in parallel with the energy storage capacitor 3 all the time.

Corresponding to one example embodiment of the present invention, only the background lighting 6 of the display apparatus is connected to the voltage supply through the energy storage capacitor 3 such that it can be switched off via a switch 9 connected in series therewith. An additional electronic circuit 10 is connected in parallel to the energy storage capacitor 3 and uses a measurement apparatus implemented in it to detect the voltage level on the energy storage capacitor 3. The voltage level on the energy storage capacitor 3 is a parameter variable that is directly proportional to its energy store state, as a result of which it is possible by comparing this voltage level with a predetermined threshold value to define a minimum energy store in the energy storage capacitor 3 which must be kept available there solely for the circuit breaker in order to initiate a disconnection process in the event of a disturbance. If the energy store on the energy storage capacitor 3 falls below the predetermined threshold value, the electronic circuit 10 produces a control signal to switch off the switch 9, as a result of which the background lighting 6 of the display apparatus, which is connected by way of this to the voltage supply through the energy storage capacitor 3, is switched off. The background lighting consumes a relatively large amount of energy and is therefore the largest additional energy consumer, while in contrast the image processing electronic circuit 6′ requires relatively little energy and can therefore still be supplied with energy. In the preferred use of an LCD display as the display apparatus, this can even still be read without background lighting provided that the lighting conditions in the surrounding area permit this.

In one example embodiment, the switch 9 is in the form of a semiconductor switch in order to allow it to be controlled electronically particularly easily and to be free of wear, but it may of course, also be in some other form, such as a relay.

The detection and processing of the voltage level on the energy storage capacitor 3 in the electronic circuit 10 can be carried out using both analog and digital technology.

When the energy storage capacitor 3 falls below a preselected minimum energy store state, the electronic circuit 10 in this way switches off the background lighting 6, whose energy supply is intensive, of a connected display apparatus which is supplied with energy from the power supply system to be monitored such that, after this, all of the remaining energy stored in the energy storage capacitor 3 is available solely for the disconnection process, which can be carried out reliably in the event of a disturbance.

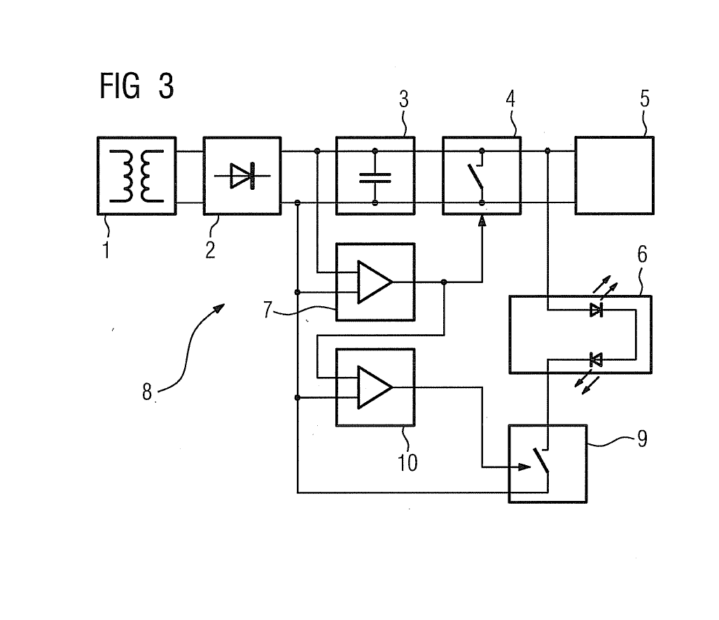

FIG. 3 shows a schematic illustration of a further example embodiment of a low-voltage circuit breaker according to an embodiment of the invention which has components very largely of the same type as the conventional embodiment of a circuit breaker described with reference to FIG. 1, for which reason the operation of these components of the same type will not be described again, with emphasis being placed on the features according to an embodiment of the invention.

This further example embodiment of the present invention has an electronic circuit 10 which controls a switch 9, in the same way as the embodiment already described with reference to FIG. 2, and background lighting 6 connected in series with it for a display apparatus, and these are also supplied with operating energy from the power supply system to be monitored.

The difference from the embodiment in FIG. 2 resides only in how the control signal for switching on and off the background lighting 6 for the display apparatus is obtained in the electronic circuit 10.

At its input, the circuit 10 receives the switching signal from the short-circuiting transistor 4, which is produced in the electronic circuit 7. This signal carries the information as to how often and for what time period the overcurrent protection is switched on, that is to say the more often and the longer the time for which the switch 4 is short-circuited, the greater is the excess energy which is fed to the circuit breaker 8 via the current sensor 1 from the power supply system to be monitored. The energy store state of the energy storage capacitor 3 can be deduced in the circuit 10 by evaluation of the switching frequency and the switching duration of the switch 4, and possibly taking account of knowledge of the characteristic of the power supply unit which consists of the circuit 7 and the short-circuiting transistor 4. If the energy store determined in this way is used as a comparison value, everything else is done in the same way as in the embodiment described with reference to FIG. 2, that is to say the determined energy store value is compared with a predetermined threshold value, and a control signal to be emitted in order to control the switch 9 is produced from the comparison. If the energy stored in the energy storage capacitor 3 falls below the predetermined threshold value, the electronic circuit 10 produces a control signal to switch off the switch 9 thus switching off the background lighting 6, which is connected in series with it to the voltage supply through the energy storage capacitor 3, for the display apparatus.

This alternative embodiment for determining the energy store state of the energy storage capacitor 3 is advantageous for some applications of low-voltage circuit breakers, in comparison to the simpler variant shown in FIG. 2.

When a preselected minimum energy store state is undershot in the energy storage capacitor 3, the electronic circuit 10 in this way switches off the background lighting 6, whose energy supply is intensive, for a connected display apparatus which is supplied with operating energy from the power supply system to be monitored, as a result of which, after this, all of the remaining energy stored in the energy storage capacitor 3 is available solely for the disconnection process to be carried, out reliably in the event of a disturbance.

The precision of the description of the example embodiments of the present invention should not be interpreted as restrictive, and modifications and variants of the present invention are possible by an average person skilled in the art without said person skilled in the art having to depart from the scope, of protection of the invention, as defined in the attached claims, to do so.

1. A circuit breaker comprising:
an electronic overcurrent protection release, which draws its power supply from a power supply system monitored by the circuit breaker;
a current sensor;
a rectifier;
an energy storage capacitor and a short-circuiting switch;
a disconnection unit;
a measurement apparatus to measure operating parameters as values of the power supply system to be monitored;
an electronic circuit to processes the measured values;
at least one electromagnetic release, controlled by the disconnection unit, to current-carrying power contacts of the circuit breaker;
an electronic display apparatus to displaying at least one of the detected and processed measured values, the electronic display apparatus being one which draws its power supply from the power supply system monitored by the circuit breaker; and
an electronic apparatus, supplied with voltage from the power supply system monitored by the circuit breaker, to controls a switching on and off of the background lighting of the electronic display apparatus, the electronic apparatus being one which draws its voltage supply from the power supply system monitored by the circuit breaker, with the aid of a switch, operateable electronically, as a function of the measured values detected in a measurement apparatus of the electronic apparatus.

2. The circuit breaker as claimed in claim 1, wherein the voltage level across the energy storage capacitor is detected in the measurement apparatus of the circuit breaker as at least one detected measured value, wherein the at least one detected measured value is compared with at least one threshold value and is processed in an electronic circuit in the measurement apparatus, and wherein a control signal for the switch, operable electronically, is generated in order to switch the switch on and off.

3. The circuit breaker as claimed in claim 1, wherein at least one of two of the operating parameters, including at least one of switching frequency and switching duration, of the short-circuiting switch is detected in the measurement apparatus of the circuit breaker, wherein the detected measured values are compared with at least one threshold value and processed in an electronic circuit in the measurement apparatus, and wherein a control signal for the switch, which operable electronically, is generated in order to switch the switch on and off.

4. The circuit breaker as claimed in claim 2, wherein the level of the threshold value for controlling the switching on and off of the background lighting of the display apparatus corresponds to a relatively low, but still adequate, energy storage supply from the energy storage capacitor in the circuit breaker through the power supply system to be monitored by the circuit breaker.

5. The circuit breaker as claimed in claim 1, wherein
the switch, operable electronically, is useable by the measurement apparatus to control the switching on and off of the entire display apparatus, including its image signal processing electronics, as a function of the detected measured values.

6. The circuit breaker as claimed in claim 1, wherein the switch, operable electronically, is in the faun of an electronic switching element, based on semiconductor technology.

7. The circuit breaker as claimed in claim 1, wherein
the circuit breaker is a low-voltage circuit breaker.

8. The circuit breaker as claimed in claim 1, wherein the display apparatus is an LCD screen.

9. The circuit breaker as claimed in claim 1, wherein the display apparatus is a type of electronic screen.

10. The circuit breaker as claimed in claim 1, wherein,
in addition to the background lighting, which is switchable off by way of the switch, for a display apparatus, at least one further additional electrical load is connected such that is switchable off.

11. A method for controlling the switching on and off of the background lighting for a display apparatus for a circuit breaker, the method comprising:
detecting at least one parameter characteristic value, associated with a power supply drawn from a power supply system to be monitored, is detected in an electronic apparatus;
comparing the detected at least one parameter characteristic value with at least one threshold value; and
generating an output signal based upon the comparing, by which an electronically operable switch is switched on and off, wherein background lighting, connected in series with the switch for a display apparatus, is switched off when an excessively low energy storage supply from an energy storage capacitor in the circuit breaker is found based upon the comparing, and when an adequate energy storage supply from the energy storage capacitor in the circuit breaker is found based upon the comparing, the background lighting for the display apparatus is switched on.

12. The method as claimed in claim 11, wherein the detecting of the at least one parameter value in the electronic apparatus includes detection of a voltage level of the energy storage capacitor.

13. The method as claimed in claim 11, wherein the detecting of the at least one parameter value in the electronic apparatus includes detection of at least one of two parameters, including at least one of a switching frequency and a switching duration of a short-circuiting switch of the circuit breaker.

14. The circuit breaker as claimed in claim 3, wherein the level of the threshold value for controlling the switching on and off of the background lighting of the display apparatus corresponds to a relatively low, but still adequate, energy storage supply from the energy storage capacitor in the circuit breaker through the power supply system to be monitored by the circuit breaker.

15. A circuit breaker comprising:
an electronic overcurrent protection release, which draws its power supply from a power supply system monitored by the circuit breaker;
a measurement apparatus to measure operating parameters as values of the power supply system to be monitored;
an electronic circuit to process the measured values;
at least one electromagnetic release to trip current-carrying power contacts of the circuit breaker;
an electronic display apparatus to display at least one of the detected and processed measured values, the electronic display apparatus being one which draws its power supply from the power supply system monitored by the circuit breaker; and
an electronic apparatus, supplied with voltage from the power supply system monitored by the circuit breaker, to control a switching on and off of background lighting of the electronic display apparatus, the electronic apparatus being one which draws its voltage supply from the power supply system monitored by the circuit breaker with the aid of a switch, operateable electronically, as a function of the measured values detected in a measurement apparatus of the electronic apparatus.

16. The circuit breaker as claimed in claim 15, wherein the voltage level across an energy storage capacitor of the circuit breaker is detected in the measurement apparatus of the circuit breaker as at least one detected measured value, wherein the at least one detected measured value is compared with at least one threshold value and is processed in an electronic circuit in the measurement apparatus, and wherein a control signal for the switch, operable electronically, is generated in order to switch the switch on and off.

17. The circuit breaker as claimed in claim 15, wherein at least one of two of the operating parameters, including at least one of switching frequency and switching duration, of a short-circuiting switch of the circuit breaker is detected in the measurement apparatus of the circuit breaker, wherein the detected measured values are compared with at least one threshold value and processed in an electronic circuit in the measurement apparatus, and wherein a control signal for the switch, operable electronically, is generated in order to switch the switch on and off.

18. The circuit breaker as claimed in claim 16, wherein the level of the threshold value for controlling the switching on and off of the background lighting of the display apparatus corresponds to a relatively low, but still adequate, energy storage supply from the energy storage capacitor in the circuit breaker through the power supply system to be monitored by the circuit breaker.

19. The circuit breaker as claimed in claim 17, wherein the level of the threshold value for controlling the switching on and off of the background lighting of the display apparatus corresponds to a relatively low, but still adequate, energy storage supply from the energy storage capacitor in the circuit breaker through the power supply system to be monitored by the circuit breaker.

20. The circuit breaker as claimed in claim 15, wherein the display apparatus is an LCD screen.

21. The circuit breaker as claimed in claim 15, wherein the circuit breaker is a low-voltage circuit breaker.

22. The circuit breaker as claimed in claim 15, wherein the display apparatus is a type of electronic screen.
